(19) United States
(12) Patent Application Publication
(10) Pub. No.: US 2009/0183253 A1
(43) Pub. Date: Jul. 16, 2009

(54) VIRUS-RESISTANT COMPUTER WITH DATA INTERFACE FOR FILTERING DATA

(76) Inventor: Lawrence Kates, Corona Del Mar, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/390,244

(22) Filed: Feb. 20, 2009

Related U.S. Application Data
(63) Continuation of application No. 11/385,024, filed on Mar. 20, 2006.

(51) Int. Cl. G06F 21/00; G06F 3/00; G06F 12/14

(52) U.S. Cl. 726/16; 710/63; 726/24

(57) ABSTRACT

A virus-proof diskless computer with data interface for filtering data is provided as a robust virus-proof user computer system. The computer system is provided without a hard drive such that the computer must boot from a disk every time the computer starts. In this way, the operating system and computer files will not be corrupted by the user's use of the machine. A data filtering interface is also provided that allows only certain data file types to be transferred through the data interface port. This will help prevent unwanted file types and viruses from being transferred to or from the computer system.

### REFERENCE TO RELATED APPLICATIONS

The present application is a continuation of application Ser. No. 11/385,024, filed Mar. 20, 2006, titled “VIRUS-RESISTANT COMPUTER WITH DATA INTERFACE FOR FILTERING DATA,” the disclosure of which is incorporated herein by reference in its entirety.

### BACKGROUND

1. Field of the Invention

The present invention relates to a virus-resistant diskless computer with integrated or external data interface ports capable of filtering and/or accepting only certain data types to prevent transmission of computer viruses.

2. Description of the Related Art

Protecting a computer from viruses has proven to be difficult and costly. New viruses are created and discovered everyday and flaws in software currently available make computers vulnerable to viral attacks. Such viral attacks cost computer owners, businesses, and others great expense to maintain and decrease the risk of viral infection.

A typical commercially-available computer system will have a number of components that make up the computer. For instance, most computers have a hard drive, a processor, RAM memory, a floppy disk drive, a monitor, a keyboard, a mouse, and optionally a printer and/or a network interface. Many computers now available will also have a data port, such as, for instance, a universal serial bus port (USB port), or a IEEE 1394 firewire port.

In operation, as a computer interfaces with a network or transfers data from a data storage device, viruses, in the form of executable computer code, can be transferred. Viruses can be downloaded from a network, such as the Internet, onto a disk or other storage device. They can be transferred from an external storage device to a computer, and they can be transferred from a computer to an external storage device. Transfer of the virus is almost always done without the knowledge of the user.

Once a virus finds its way onto a computer system, it can be difficult to detect, and difficult to remove. Currently available viral protection software affords some protection, but new viruses are often created which viral protection software cannot detect. In many cases, the only way to remove a virus is to reformat a hard drive, effectively deleting the contents of the entire computer system, and costing time and energy to reload software.

A need exist for a computer that is very robust and capable of reducing or eliminating the risk of computer virus infections.

### SUMMARY

These and other problems are solved by providing a virus-resistant diskless computer with one or more data interfaces for filtering data. In the present system, data can be transferred while executable code cannot be transferred. This is because executable code may contain a virus, while data generally does not contain viruses. It is possible that a virus may be hidden in a data file, and for this reason a system is provided to look at the data in a data file for evidence of any hidden code. For instance, a malicious programmer may rename a virus with a data file extension. In such cases, simply looking at the file extension is not enough. The system must look in the file to see if the file contains only data, or if there is executable code hidden inside. Thus, the present system allows data to be transferred while preventing executable code from being transferred.

The virus-resistant diskless computer is designed to operate without a hard drive such that every time the computer is turned on, it boots from a read-only device rather than from the hard drive. The computer is restored to its default state every time the computer is booted. This is possible because RAM memory is erased every time the computer turns off and is restored every time the computer turns on. The boot device, such as a CD or DVD cannot be infected with a virus, because once created, the disc cannot be changed. If a virus does find its way onto the computer, all a user has to do to erase the virus is to turn the computer off and restart it. In addition, even if a virus were downloaded, it would only affect a single use session, and then would be eliminated when the computer is shut down. In this way, the executable code is restored to its default every time the computer is turned off and on.

In one embodiment, the virus-resistant diskless computer can be used both in the home and in public venues. For example, parents may want to provide a limited computer system to their children. The present computer system can be designed by the parent to have only certain programs and capabilities, and a child will not be able to change those settings. The present computer system can also be valuable in public venues, such as, for example, libraries, schools, and cyber cafes. In these public venues, computer owners often have only limited control over who uses a computer. In addition, the present computer system can be limited to certain uses, for instance, a library may not want users to download music files off the Internet. Thus, the library may restrict data transfer for music files, while allowing transfer of other types of files.

In one embodiment, the virus-resistant diskless computer can also be provided with a data interface such as, for example, a USB or 1394 fire wire interface. The interface is made so that it will only transfer designated data types. For example, a data interface port is provided that will only transfer music files or image files. Executable files, such as viruses, will not be transferred through the interface. In this way, only data can be transferred and executable code will not be transferred. In one embodiment, multiple data interface ports are provided, each capable of transferring a different file type. For example, one data interface port can transfer only music files, while another can transfer only picture files. In one embodiment, multiple data interface ports are provided all of which are capable of transferring the same designated types of files. For example, multiple data interface ports can be provided, each capable of transferring only music files, video files, image files, and word processing files but not executable files. In one embodiment, specially shaped or colored data interface connectors are provided so that a user will only be able to connect certain devices to certain data interface ports. For instance, a user's MP3 player will have a connector that will only fit a data interface port that transfers music files.

In one embodiment, a standalone data interface hub is provided, such as, for example, a USB hub which contains within it a firewall for filtering out certain files and only transferring file types which are designated. For example, a USB hub can be provided with various ports, each port configured to transfer a different type or class of files. The firewall can be provided on each of those data ports to only transfer the designated file types. In addition, in one embodiment, the firewall checks the file type to make sure the file's code matches the file type. In this way an executable file designated with a music file extension will not be transferred. A standalone (or inline) filter hub can be used with any existing computer system.

In one embodiment, a program selection interface is provided. The computer boots from a read-only memory device, and as such, the disc must have on it all of the computer programs a user wishes to use. In one embodiment, a user logs onto a network address or web site interface and chooses the programs the user wishes to have on the computer. The chosen programs will then be burnt onto a CD or DVD placed on a flash drive and sent to the user. In one embodiment, the user can use a kiosk to select which programs they wish to have on their computer. The programs will then be burnt onto a CD or DVD and given to the user. In one embodiment, the interface is provided in the form of a computer program that a system administrator (or parent) can use to select different program functionality for different computers. For instance, in the case of a parent, the parent may want different programs for children of different ages.

### BRIEF DESCRIPTION OF THE DRAWINGS

FIG. 1 shows one embodiment of a virus-resistant diskless computer system.

FIG. 2 shows an interior schematic drawing of one embodiment of a diskless computer system.

FIG. 3 shows one embodiment of a diskless computer system with dedicated data interface ports.

FIG. 4 shows one embodiment of a diskless computer system with firewalled data interface ports.

FIG. 5 shows one embodiment of a diskless computer system with different shaped computer interface plugs.

FIG. 6a shows a side view of one embodiment of a diskless computer system.

FIG. 6b shows a front view of the embodiment of FIG. 6a.

FIG. 7 shows an illustration of one embodiment of a computer program selection interface for creating a CD useable in a diskless computer system.

FIG. 8 shows a flowchart of a computer program selection system.

FIG. 9 shows a flowchart of the operation of the diskless computer system.

FIG. 10 shows a flowchart of a protected data interface port.

FIG. 11 shows a schematic diagram of a standalone data interface firewall hub.

FIG. 12 shows a schematic diagram of a standalone data interface with a firewall between the input port and output port.

### DETAILED DESCRIPTION OF THE PREFERRED EMBODIMENT

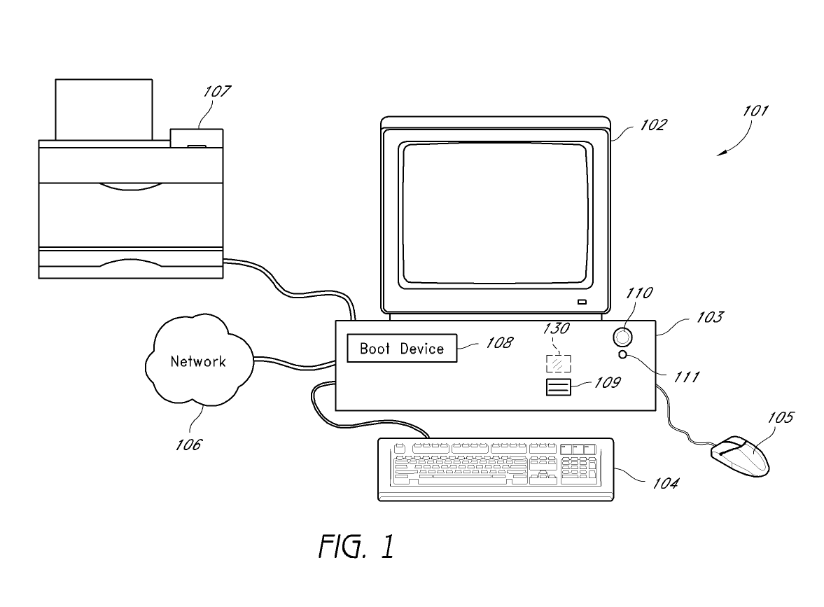

FIG. 1 shows one embodiment of a virus-resistant diskless computer system 101 with a monitor 102, a computer housing 103, a keyboard 104, a mouse 105, a network 106, a printer 107, a read-only drive 108, a data interface 109, a power button 110, and a reset button 111. The diskless computer system 101 is provided to the monitor 102 for the mouse 105 and the keyboard 104. The diskless computer system 101 can optionally be provided to network interface 106 such as, for example, the Internet or World Wide Web. The diskless computer system 101 can also optionally be attached to a printer 107. The disk drive 108 can include a CD drive, a DVD drive, a CDR, a CDRW, DVDR, DVDRW, or flash drive or any other suitable drive known in the art. The data interface port 109 can include a USB interface, a 1394 fire wire interface or other drive capable of interfacing and communicating data to the diskless computer 101.

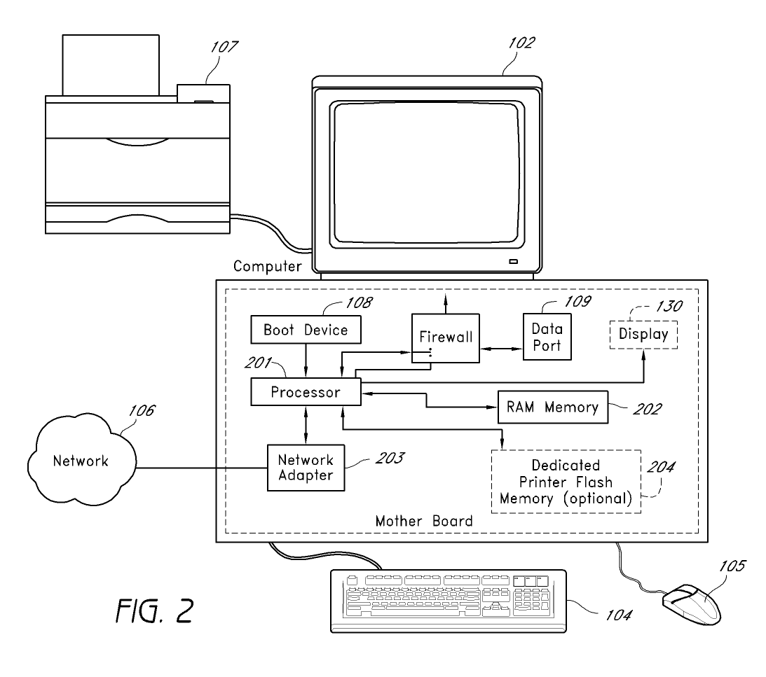

FIG. 2 shows a diagram of the interior of a diskless computer system 101. As shown in FIG. 2, in one embodiment, a virus-resistant diskless computer is built without a hard disk drive. The diskless computer has a read-only boot device 108, data port 109, processor 201, RAM memory 202, network adapter 203, and optional dedicated printer flash memory 204. Other computer components known in the art may also be included in the diskless computer system. For example, graphic cards and/or sound cards may be included.

The boot device 108 can be used to read an operating disk which contains all the programs that will be run by the virus-proof diskless computer 101. The computer boots from the boot device every time the computer is turned on. Data port 109 is provided in order to create a storage system for a diskless computer 101. In one embodiment, the diskless computer can write to a CD or DVD to create storage. In one embodiment, multiple removable storage devices are provided, one for running the boot media, and another for reading and writing other data. In one embodiment, the boot media is provided with an electronic key and the computer's bios is provided with a corresponding electronic key. In this way, the computer will only boot from boot media with a key that matches the key in the bios. In one embodiment, a user cannot enter executable code except from a boot device. Thus, the virus-resistant computer is able to quarantine and protect read/write storage.

In one embodiment, a dedicated printer flash memory 204 is provided in order to allow the diskless computer 101 to store printer information in the event that a user-connected printer 107 is not supported by a driver on the boot disc. In this situation, the printer flash memory can store the name of the printer and when the computer is turned on, the computer can go to a designated network address and download the correct printer driver.

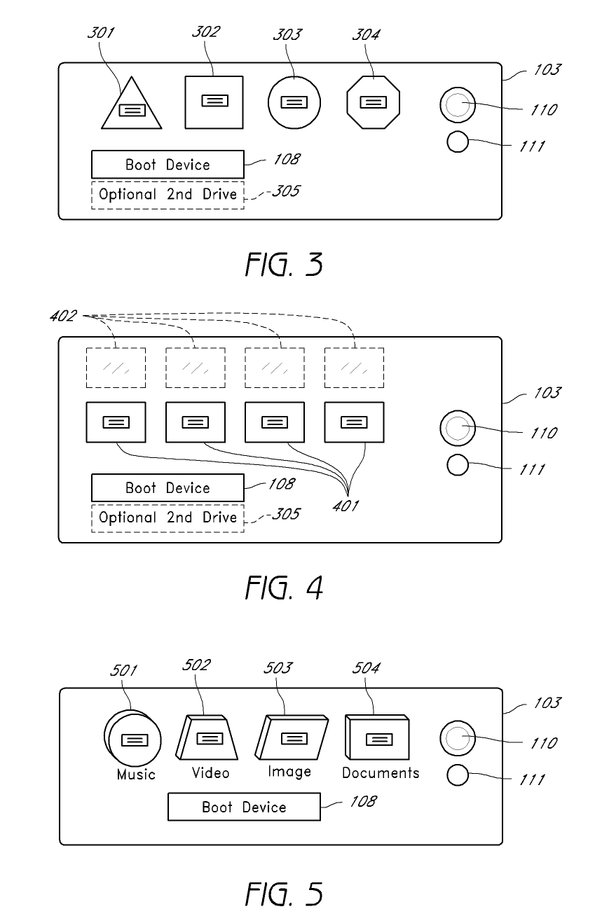

FIG. 3 shows a front view of one embodiment of a diskless computer 101. As illustrated, various data interface ports 301-304 are provided. The data interface ports 301-304 are provided with various markings on them which indicate which file types the various ports will accept. For example, in one embodiment, a first port can be designated to only transfer music files, a second port can be designated to only transfer video files, a third port can be designated to only transfer image files, and a fourth port can be designated to only transfer document files. In one embodiment, different shapes are used to designate which files the ports will accept. For example, a first shape can indicate that the port transfers only music files, a second shape can indicate that the port transfers only image files. In one embodiment, graphics are used to indicate port designations. For example, a graphic of a camera may indicate that a port only accepts image files. A graphic of a clef note can indicate that the port only accepts music files. In one embodiment, colors are used to indicate port compatibility. In one embodiment, a liquid crystal display (LCD) screen is used to indicate which file types a port will accept. The ports can be configurable by the user so that a user may designate which file types a port may transfer. As the port is configured, the LCD display will change to indicate the newly designated file types.

FIG. 3 also shows the optional incorporation of a second disc drive 305. A second disc drive can be provided to read or write from a disc other than the boot disc, providing another option for storing or transferring data. The second disc drive 305 can also be provided with a firewall such that only data files can be transferred from or to the second disc drive 305. In this way, no executable code will be transferred to or from the disk drive 305.

FIG. 4 shows one embodiment of a diskless computer in which multiple data interface ports 401 are provided, all of which transfer the same types of files. In this embodiment, all of the ports can transfer the same set of designated file types. For instance, the ports 401 can all transfer music, video, image, and document files, but can be configured to prevent executable files from being transferred.

FIG. 5 shows one embodiment of diskless computer 101 with differently shaped data interface plugs 501-504. Data interface ports 501-504 are created to accept only certain shaped data interface plugs. For example, a first data interface port may be created to only connect with data interface plugs of a first shape. A second data interface port may only connect with data interface plugs having a second shape, and so on. Various shapes and combinations of shapes may be used to designate file transfer compatibility. In this way, a user will only be able to connect devices which are made for transferring specific types of files. For example, in one embodiment, a data interface plug for connecting an MP3 player may be shaped like a circle so that it will only be connectable with the a data interface port for transferring music files.

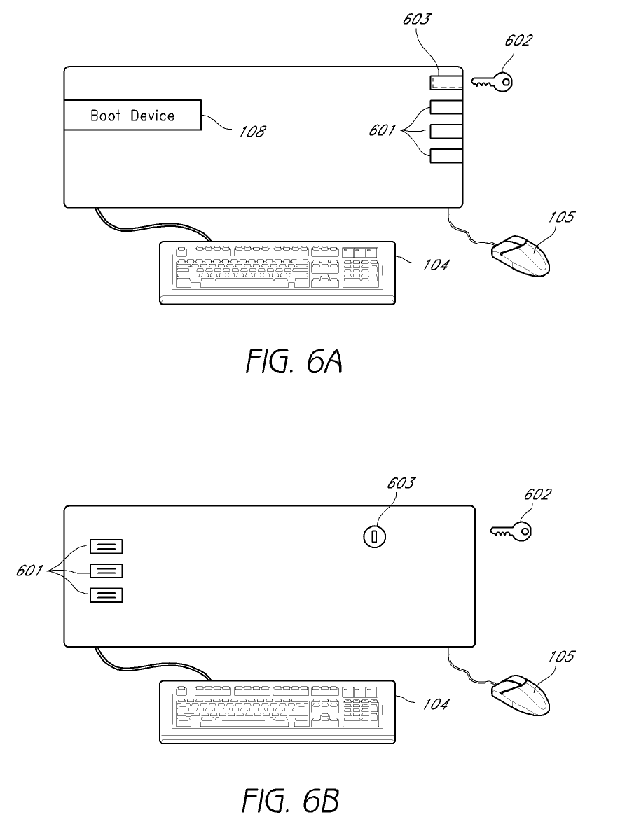

FIG. 6a shows another embodiment of a diskless computer 101. In this embodiment, the boot device 108 is located in the rear of computer housing 103 such that it is not accessible by a user on a day to day basis. In addition, FIG. 6a shows a power and/or reset button 603 which is only capable of being operated using key 602 such that a user will be required to have the key 602 in order to turn the computer on or off or reset the computer. In this way, the computer may be used in a public environment, or by young children, without worry that the user will be able to turn on or off the computer or have access to remove the boot media. Data ports 601 can also be provided for transferring data.

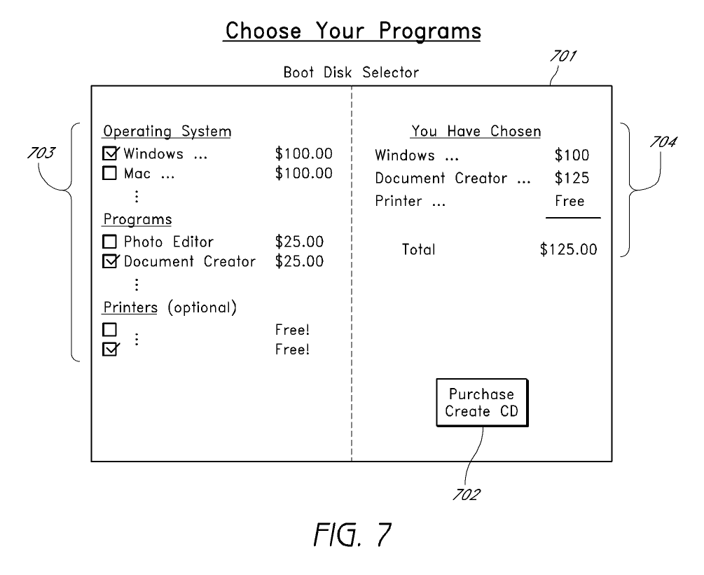

FIG. 7 shows one embodiment of a program selection interface 701. In this embodiment, a user can log onto a network site, such as one posted on the Internet or Worldwide Web to use a program selection interface. In one embodiment, the user will be able to use a kiosk, such as in a store, in order to select the programs for their diskless computer. The program selection interface 701 allows a user to be able to select which programs they want their computer to have from a pre-selected group of programs, such as program list 703. The chosen programs are then added to the selected programs column 701. Once the user has selected all of the desired programs, the user can push the Purchase/Create Disk CD button 702 to begin the checkout and/or burn process. In one embodiment, each program will have a different price associated with it. A user will then be required to pay a total amount for all of the selected programs. In one embodiment, a selection of programs will come standard with the computer hardware, and a user can add programs for an additional charge. In one embodiment, a user will have an account and will be able to trade in used programs for new programs. In one embodiment, a user is required to trade in their boot disc for a new boot disc upon the selection of new programs. In one embodiment, a user is allowed to have a set number of programs. For instance, in addition to a standard set of programs, a user may be allowed to have any three additional programs. The user will then be allowed to trade in those programs for other programs.

In one embodiment, the boot media are encrypted so that they will only be able to work with diskless computer systems capable of decrypting the programs. In this way, boot disk owners will not be able to install software from the boot disk onto other computer systems. This will prevent illegal copying of computer programs. In one embodiment, the boot disk is encrypted so that only the intended user's computer will be able to decrypt the boot disk.

In one embodiment, a program selector interface program is provided to a system administrator in order to pick and choose which programs various computers within the administrator's purview will have. Thus, a system administrator will not be required to go through a third party in order to change the programming scheme of the computers within their purview. A program selector interface program can also allow an administrator to add programs to the boot disk which may not be listed on a vendor's program selection interface site.

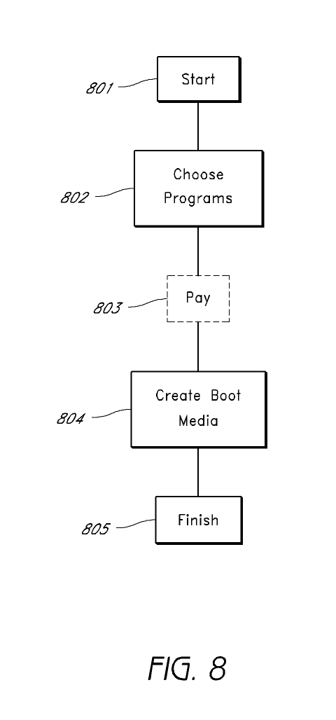

FIG. 8 shows a flowchart of a program selector interface. The flowchart begins with block 801 where a user begins the process. This is done by logging onto a vendor's network address, by entering the selection process on a kiosk, or by running a program selector interface program. The process then moves onto block 802 where a user selects which programs they want. After block 802, the system then optionally moves onto block 803. At block 803, a user pays for the programs chosen in block 802. Block 803 may be skipped in some embodiments, for instance, where a system administrator is choosing which programs to add to computers within their purview. The system then moves onto block 804 where the boot media is created with the programs selected in block 802. The system then finishes at block 805 where the boot disk is conveyed to the user.

There are various methods for implementing the system of FIG. 8. For instance, a user kiosk may have a disk creator built into it such that a boot disk is conveyed directly to the user at the time of selection. In one embodiment, the kiosk sends the user's selection to another system for creation and the boot disk is then mailed to the user, or is given to the user by another person. In the situation where the selection occurs on the internet, the boot disk can be mailed to the user. In the situation where an administrator is using a program selector interface program, the administrator can create boot disks with the computer running the selector interface software.

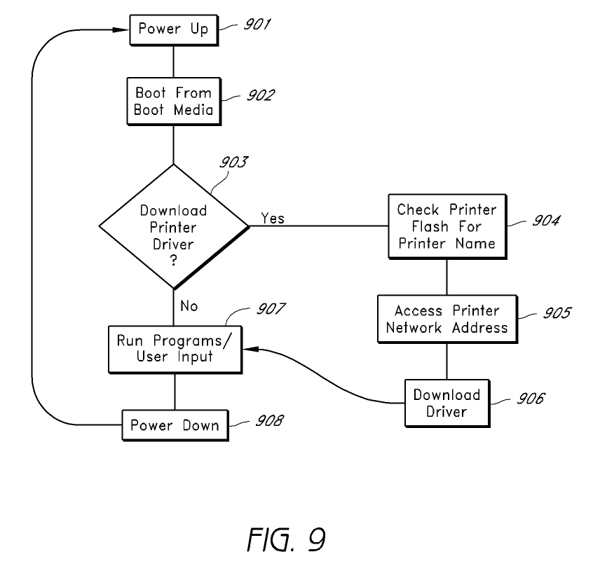

FIG. 9 shows a flowchart of the operation of a virus-resistant diskless computer 101. Operation begins at block 901 where the computer is powered up. The computer is then booted from the boot media at block 902. The computer goes on to decision block 903 where the computer chooses whether it needs to download a printer driver. In one embodiment, if a printer driver needs to be downloaded, the system will go on to block 904 where it will check the printer flash or determine printer type for the printer name. The system will then move to block 905 where it will access the printer network address to download the correct printer driver. At block 906, the driver is downloaded. The system then moves to block 907. If at block 903 no printer driver needs to be downloaded, the process will move on to block 907. At block 907, the computer runs programs and accepts user inputs until the user is finished using the computer. The process then moves onto block 908 where the computer is powered down by the user and the computer's RAM memory is erased.

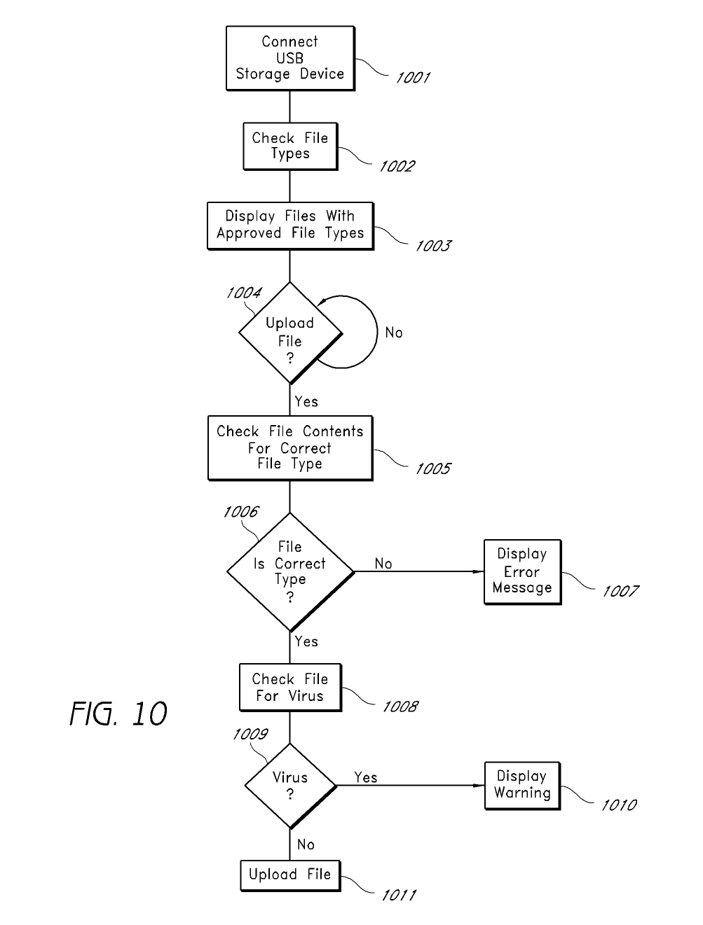

FIG. 10 shows a flowchart diagram depicting the use of a data interface filter system. Although various data interface systems can be used, such as 1394 firewire, the flowchart of FIG. 10 will be described in terms of using a USB device interface port. In addition, the flowchart of FIG. 10 will be described in relation to a diskless computer, however, the data interface filter process described in FIG. 10 is equally applicable to a filter system provided either internally or externally with any computer system. Thus the use of specific devices in FIG. 10 is done for illustrative purposes and is not meant to be limiting.

The flowchart of FIG. 10 begins at block 1001 where a user connects a USB device to diskless computer 101. The process then moves on to block 1002 where the filter system checks the file types of the files stored on the USB device. The diskless computer 101 then displays approved file types on monitor 102 at block 1003. The system then moves on to block 1004 where the diskless computer 101 waits for a user to choose which files to transfer. The system will wait at block 1004 until the user closes the file display screen or the user chooses a file to transfer. In addition, the user may choose to transfer a file to the USB device. In this situation, the process for transferring a file to the USB device will continue in the same way as though a user where transferring a file from the USB device.

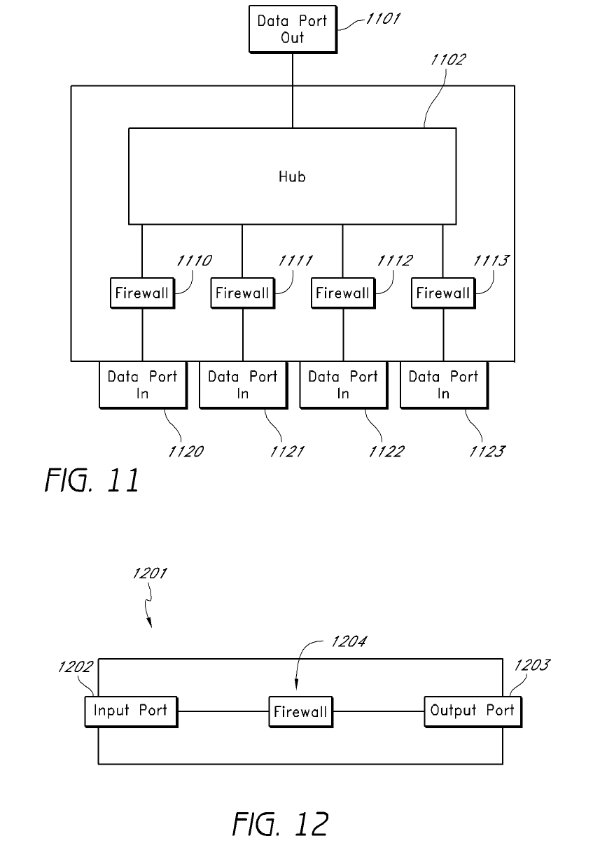

Once a file is chosen, the process moves on to block 1005 where it checks the file contents. The filter system looks at the file's code to make sure that the code sequence matches the file type as will be described with reference to FIG. 11. The process then moves onto decision block 1006. At decision block 1006, if the code does not match the file type designation, then the process moves onto block 1007 where an error message is displayed on the computer monitor and the file is not downloaded. If the file type is correct, the system then moves onto block 1008 where a software virus check program is run on the file to double check that a virus is not present. At decision block 1009, if a virus is found, then the process moves onto block 1010 where a warning message is displayed on the computer monitor and the file is not downloaded. If there is no virus found at block 1009, then the process moves onto block 1011 where the file is uploaded. The process then returns to block 1003 where it redisplays the file contents of the USB device and waits for a user input.

FIG. 11 shows a schematic diagram of one embodiment of a data I/O port firewall configuration. In FIG. 11, I/O ports 1020-1023 are provided for connecting storage devices. Firewalls 1110-1113 are provided for filtering information that is transferred through data ports 1120-1123. Hub 1102 is provided to route information from data input ports 1120-1123 to data output port 1101 which goes to a computer interface. Although the embodiment of FIG. 11 shows four data input ports, any number of input ports will work with the filter hub. In addition, the filter can be located between the data input ports 1120-1123 and the hub 1102, or a single filter can be located between hub 1102 and data output port 1101. In one embodiment, there is no hub. Thus, only a data input connection, filter, and output connection is provided, such as, for example, the embodiment of FIG. 12.

Filters 1110-1113 filter out both data types that are unacceptable as well as looking at the code within the files to make sure it matches the file type. This firewall system prevents viruses, such as executables and other viruses hidden inside a file, from entering into the hub and out through data port 1101 to a computer.

In one embodiment, the firewall system is user configurable such that a user can reconfigure what types of files will pass through the firewall. In one embodiment, each port has an LCD display for displaying what types of files a particular port will accept. In one embodiment the ports will not allow transfer of any executable code. In one embodiment, only specific types of files will be transferred. In one embodiment, the ports include DRM checking. In one embodiment, the ports include virus and DRM checking.

The filters can be implemented in both hardware and software. The filters are made to be able to look at the code within a file to make sure the code matches characteristics of a particular file. For instance, executable code looks very different than code in a music file. in one embodiment, the filters are able to look at the code and know whether the file contents are of the correct file type.

FIG. 12 shows one embodiment of a data port firewall. In FIG. 12, a single data port 1201 is shown with input connector 1202 and output connector 1203. Firewall 1204 is provided between input connector 1202 and output connector 1204.

In one embodiment, the firewall is user configurable such that a user can reconfigure what types of files will pass through the firewall. In one embodiment, an LCD display is provided for displaying what types of files the device will transfer. In one embodiment the device will not allow transfer of any executable code. In one embodiment, only specific types of files will be transferred. In one embodiment, the device includes DRM checking. In one embodiment, the ports include virus and DRM checking.

It will be evident to those skilled in the art that the invention is not limited to the details of the foregoing illustrated embodiments and that the invention can be embodied in other specific forms without departing from the spirit or central attributes thereof. Furthermore, various admissions, substitutions, and changes can be made without departing from the spirit of the invention. For example, any number of data input ports may be provided. Various types of data interface ports may be provided. Various configurations of the data interface ports may be used. Various colors, shapes, and sizes of data interface ports may be used with the invention. The diskless computer system 101 may comprise various components not illustrated in the figures provided. The foregoing description of the embodiments is, therefore, to be considered in all of respects as illustrative and not restrictive with the scope of the invention being delineated by the appended claims and their equivalence.

What is claimed is:

1. A computer comprising:
a boot device configured for reading a read-only boot media;
RAM memory;
a processor; and
at least one data interface port configured to transfer only designated file types, while restricting transfer of other file types able to be conveyed by the data interface port include firewall port.

2. The computer of claim 1, wherein the data interface port is marked for the type of files transferable through the data interface port.

3. The computer of claim 2, wherein the data interface port is marked with a music files only designation.

4. The computer of claim 2, wherein the data interface port is marked with a video files only designation.

5. The computer of claim 2, wherein the data interface port is marked with a image files only designation.

6. The computer of claim 2, wherein the data interface port is marked with a word processing files only designation.

7. The computer of claim 2, wherein the data interface port marking comprises an LCD display.

8. The computer of claim 1, wherein the data interface port is connectable with a plug, wherein the shape of each plug head and corresponding shape of each data interface port is chosen to correspond to a particular file type transferable through the data interface port.

9. The computer of claim 8, wherein the shape corresponds with a music files designation.

10. The computer of claim 8, wherein the shape corresponds with a video files designation.

11. The computer of claim 8, wherein the shape corresponds with a image files designation.

12. The computer of claim 8, wherein the shape corresponds with a word processing files designation

13. A data transfer filter comprising:
an input connector;
an output connector; and
a filter system which prevents transfer of at least one type of file and inspects the file code to ensure that it matches the file type.

14. The data transfer filter of claim 13 further comprising a hub.

15. The data transfer filter of claim 13, wherein the input connector and output connector are Universal Serial Bus compatible.

16. The data transfer filter of claim 13, wherein the input connector and output connector are IEEE 1394 compatible.

17. The data transfer filter of claim 13, wherein the input connector and output connector are IEEE 1394 compatible.

18. A data transfer filter comprising:
an input connector;
an output connector; and
a filter system which inspects the file code and identifies the file type.

19. The data transfer filter of claim 18 further comprising a hub.

20. The data transfer filter of claim 18, wherein the input connector and output connector are Universal Serial Bus compatible.
